(19) United States
(12) Patent Application Publication
(10) Pub. No.: US 2023/0075801 A1
(43) Pub. Date: Mar. 9, 2023

(54) Windows With Laminated Glass Layers

(71) Applicant: Apple Inc., Cupertino, CA (US)

(72) Inventors: David E Kingman, San Francisco, CA (US); Albert J Golko, Saratoga, CA (US); Dale N Memering, New York, NY (US); Peter F Masschelein, Campbell, CA (US)

(21) Appl. No.: 17/881,517

(22) Filed: Aug. 4, 2022

Related U.S. Application Data
(60) Provisional application No. 63/242,125, filed on Sep. 9, 2021.

(51) Int. Cl. B32B 17/10; B32B 7/12; B32B 7/023

(52) U.S. Cl. CPC B32B 17/10504; B32B 7/12; B32B 7/023; B32B 17/10036; B32B 17/10541; B32B 17/10889; B32B 17/10761; B32B 2250/04; B32B 2307/42; B32B 2307/418; B32B 2307/416; B32B 2605/006

(57) ABSTRACT

A vehicle or other system may have windows. The windows may be formed by laminating together glass layers. The glass layers may include a curved inner glass layer with a convex outer surface and a curved outer glass layer with a concave inner surface. A polymer adhesive film such as a polyvinyl butyral film may be adhered to the convex outer surface. An additional polymer layer formed from a different material than the polymer film may be interposed between the polymer film and the second glass layer. The additional polymer layer may be formed from a gap-filling liquid polymer adhesive layer. The layer of gap-filling liquid polymer adhesive may have a first surface adhered to the polymer film and a second surface adhered to the concave inner surface. An optical layer may be embedded in the additional polymer layer.

This application claims the benefit of provisional patent application No. 63/242,125, filed Sep. 9, 2021, which is hereby incorporated by reference herein in its entirety.

### FIELD

This relates generally to structures that pass light, and, more particularly, to windows.

### BACKGROUND

Windows are used in buildings and vehicles. Windows may be formed from glass or other transparent material.

### SUMMARY

A vehicle or other system may have windows. The windows may be formed by laminating together first and second molded glass layers using multiple layers of adhesive. In this way, manufacturing-induced thickness variations in the first and second molded glass layers may be accommodated.

The first glass layer may be a curved inner glass layer having a convex outer surface. The second glass layer may be a curved outer glass layer with a concave inner surface. A polymer film such as a polyvinyl butyral film may be adhered to the convex outer surface (or, in some embodiments, to the concave inner surface). An additional polymer layer formed from a different material than the polymer film may be interposed between the polymer film and the second glass layer (or, in some embodiments, between the polymer film and the first glass layer).

The additional polymer layer may be formed from a gap-filling liquid polymer layer. In an illustrative configuration, the gap-filling liquid polymer layer may have a first surface adhered to the polymer film and a second surface adhered to the concave inner surface. An optical layer may be embedded in the additional polymer layer. The optical layer may be an electrically adjustable optical layer such as an adjustable light modulator layer or other optical layer with an electrically adjustable optical characteristic (e.g., adjustable haze, adjustable polarization, adjustable reflectivity, adjustable color cast, etc.). If desired, the optical layer may be a light guide core layer and the additional polymer layer may serve as cladding for the light guide core layer.

### BRIEF DESCRIPTION OF THE DRAWINGS

FIG. 1 is a diagram of an illustrative system with windows in accordance with an embodiment.

FIG. 2 is a cross-sectional side view of an illustrative tool for molding a glass layer into a desired shape with a curved-cross-sectional profile in accordance with an embodiment.

FIG. 3 is a diagram of a window during lamination with a single layer of adhesive illustrating how there is a risk of gap formation when glass layers are uneven in thickness.

FIGS. 4, 5, and 6 are cross-sectional side views of illustrative window structures during window formation in accordance with an embodiment.

FIG. 7 is a cross-sectional side view of an illustrative window with an embedded optical layer in accordance with an embodiment.

### DETAILED DESCRIPTION

A system may have one or more windows. The windows may have layers of molded glass that are laminated together using adhesives. The system in which the windows are used may be a building, a vehicle, or other suitable system. Illustrative configurations in which the system is a vehicle may sometimes be described herein as an example. This is merely illustrative. Window structures may be formed in any suitable systems.

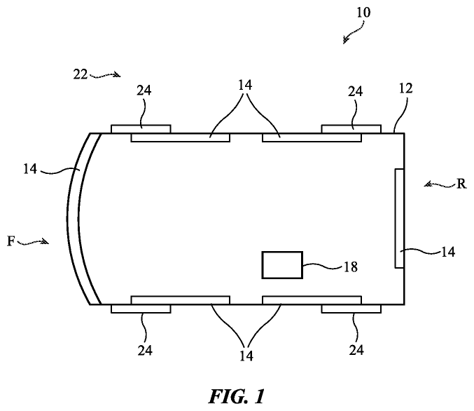

A cross-sectional top view of an illustrative system that includes windows is shown in FIG. 1. System 10 may be a vehicle, building, or other type of system. In an illustrative configuration, system 10 is a vehicle. As shown in the illustrative top view of system 10 in FIG. 1, system 10 may have support structures such as body 12. Body 12 may be a vehicle body that includes doors, trunk structures, a hood, side body panels, a roof, window pillars, and/or other body structures. Body 12 may be configured to surround and enclose an interior region such as interior region 20. System 10 may include a chassis to which wheels such as wheels 24 are mounted, may include propulsion and steering systems, and may include a vehicle automation system configured to support autonomous driving (e.g., a vehicle automation system with sensors and control circuitry configured to operate the propulsion and steering systems based on sensor data). This allows system 10 to be driven semi-autonomously and/or allows system 10 to be driven autonomously without a human operator. Manual driving operations may also be supported.

One or more windows such as windows 14 may be mounted within openings in body 12. Windows 14 may, for example, be mounted on the front of body 12 (e.g., to form a front window on vehicle front F), on the rear of body 12 (e.g., to form a rear window at vehicle rear R), on the top (roof) of body 12 (e.g., to form a sun roof), and/or on sides of body 12 (e.g., to form side windows). Windows 14 may include windows that are fixed in place and/or may include windows that can be manually and/or automatically rolled up or down. For example, one or more windows 14 may be controlled using window positioners (e.g., window motors that open and close windows 14 in response to user input or other input). The area of each window 14 may be at least 0.1 m², at least 0.5 m², at least 1 m², at least 5 m², at least 10 m², less than 20 m², less than 10 m², less than 5 m², or less than 1.5 m² (as examples). Windows 14 and portions of body 12 may be used to separate interior region 20 from the exterior environment that is surrounding system 10 (exterior region 22).

System 10 may include components 18. Components 18 may include seats in the interior of body 12, sensors, control circuitry, input-output devices, and/or other vehicle components. Control circuitry in system 10 may include one or more processors (e.g., microprocessors, microcontrollers, application-specific integrated circuits, etc.) and storage (e.g., volatile and/or non-volatile memory). Input-output devices in system 10 may include displays, sensors, buttons, light-emitting diodes and other light-emitting devices, haptic devices, speakers, and/or other devices for providing output and/or gathering environmental measurements and/or user input. The sensors may include ambient light sensors, touch sensors, force sensors, proximity sensors, optical sensors, capacitive sensors, resistive sensors, ultrasonic sensors, microphones, three-dimensional and/or two-dimensional image sensors, radio-frequency sensors, and/or other sensors. Output devices may be used to provide a user with haptic output, audio output, visual output (e.g., displayed content, light, etc.), and/or other suitable output.

During operation, control circuitry in system 10 may gather information from sensors (e.g., environmental sensors) and/or other input-output devices, may gather user input such as voice commands provided to a microphone, may gather touch commands supplied to a touch sensor, may gather button input supplied to one or more buttons, etc. Control circuitry in system 10 may use this input in driving system 10 and in controlling windows and other parts of system 10.

Windows 14 may be formed from one or more glass layers. For example, two or more glass layers may be laminated together using polymer. The glass layers may be chemically or thermally tempered (e.g., to create compressive stress on the surfaces of the glass layers). The glass layers of windows 14 may sometimes referred to as structural glass layers due to the ability of such layers to provide structural support for windows 14. In some configurations, waveguide layers with light extraction features for providing in-window illumination, light modulating layers (e.g., layers exhibiting electrically adjustable amounts of light transmission), adjustable-haze layers, adjustable-reflectivity layers, and/or other electrically adjustable window layers may be incorporated into windows 14 (e.g., such layers may be laminated between outer and inner glass layers and/or other transparent window layers).

Windows 14 may have one or more planar portions and/or one or more curved portions. As an example, one or more portions of window 14 may be characterized by a curved cross-sectional profile and may have convex and/or concave exterior surfaces (and corresponding concave and/or convex interior surfaces). The curved portions of windows 14 may include curved surfaces that can be flattened into a plane without distortion, which are sometimes referred to as developable surfaces. The curved portions of window 14 may also include curved surfaces with compound curvature, which cannot be flattened into a plane without distortion and which are sometimes referred to as non-developable surfaces or doubly curved surfaces.

Glass layers for windows 14 may be formed by molding glass sheets such as planar sheets of float glass into desired shapes and subsequently laminating these molded sheets together using adhesive.

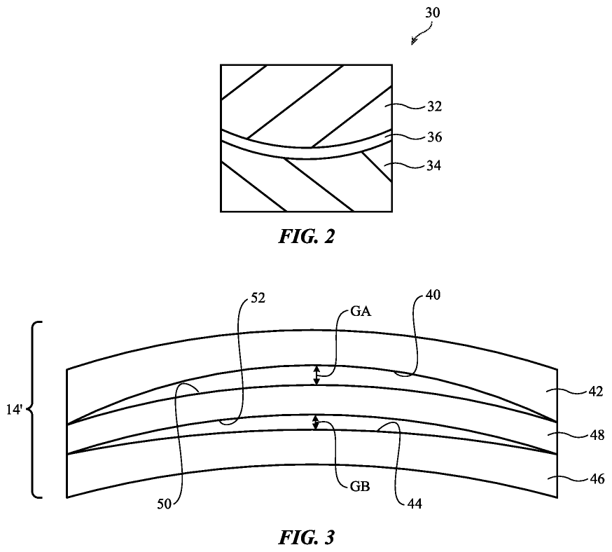

FIG. 2 is a cross-sectional side view of an illustrative layer of glass during molding operations. As shown in FIG. 2, glass molding tool 30 may include mating dies 32 and 34. Once die may have a convex surface and other die may have a corresponding concave surface. Under heat and pressure (e.g., pressure formed by moving dies 32 and 34 together), a planar sheet of glass may be molded into a desired shape (e.g., a shape with a curved cross-sectional profile having non-planar surfaces such as developable surface areas and/or areas of compound curvature). If desired, molding tool 30 may be a single-sided molding tool based on a male pressing die or a female vacuum-pull die and/or other glass molding techniques may be used (e.g., molding tool 30 may have a slumping mold, may perform gravity-based shaping operations, and/or may otherwise be used in forming molded glass layers). The arrangement of FIG. 2 that shows the use of two mating dies is illustrative.

After forming multiple molded glass layers such as layer 36 of FIG. 2, these layers can be laminated together using polymer adhesive. An example of an adhesive that may be used during lamination operations is polyvinyl butyral (PVB). The use of PVB during lamination may help enhance window safety. During a vehicular accident or other event in which a window breaks, the presence of PVB between the glass layers of the window helps prevent cracks from propagating between the glass layers and helps contain loose glass fragments.

During molding operations, glass layers such as layer 36 of FIG. 2 may stretch and otherwise deform. This can lead to manufacturing variations such as areas of varying thickness. FIG. 3 is a cross-sectional side view showing how glass thickness variations (e.g., thickness variations in molded glass layers with curved surfaces) can lead to a potential for undesired air gaps between glass layers when these layers are laminated to form a window (window 14′). In the example of FIG. 3, the shape of inner surface 40 of outer glass layer 42 does not precisely match the shape of outer surface 44 of inner glass layer 46 due to thickness variations in layers 42 and 46. As a result, when attempting to laminate glass layers 42 and 46 together with a polymer adhesive film such as PVB layer 48, an undesired air gap GA can form between outer surface 50 of PVB layer 48 and inner surface 40 and/or an undesired air gap GB can form between inner surface 52 of PVB layer 48 and outer surface 44 of glass layer 46, leading to incomplete bonding between layers 42 and 46.

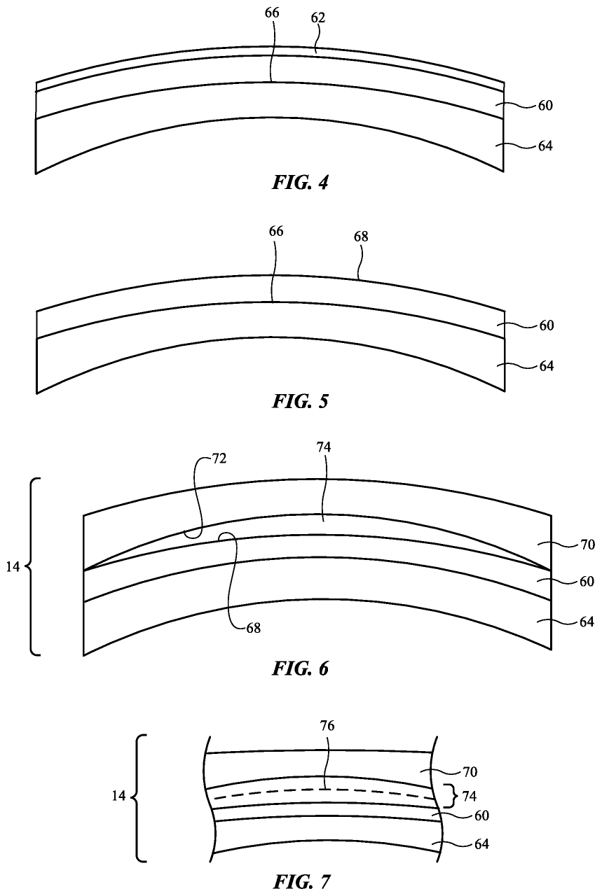

This concern can be addressed using an approach of the type shown in the cross-sectional side views of FIGS. 4, 5, and 6.

Initially, a polymer adhesive film such as PVB layer 60 is attached to outer surface 66 of glass layer 64. In the present example, glass layer 64 is an inner window layer with a curved cross-sectional profile such as an inner glass layer with a convex outer surface 66. Layer 64 may be molded into a desired shape using molding equipment such as molding tool 30 of FIG. 2. Surface 66 may have areas with developable surfaces and/or may have areas with compound curvature. If desired, glass layer 64 may have concave curvature and/or may be an outer window layer. The example of FIG. 4 is illustrative.

Release liner 62 is used as a carrier for layer 60 prior to attachment of layer 60 to layer 64. During lamination (e.g., using vacuum lamination in an autoclave to avoid formation of air bubbles), heat is applied to soften layer 60 and cause layer 60 to flow and become sticky while pressure is applied to the exposed surface of release liner 62. The pressure on liner 62 presses the layer 60 against surface 66 to adhere layer 60 to layer 64. Release liner 62 is formed from a non-stick sheet such as a sheet of flexible polymer and is used to support and dispense PVB film 60 during lamination. Following adhesion of layer 60 to surface 66 of glass layer 64, release liner 62 may be removed (e.g., liner 62 may be peeled away from layer 60), leaving outer surface 68 of PVB layer (PVB film) 60 exposed, as shown in FIG. 5.

After layer 60 is attached to glass layer 64, an additional glass layer such as layer 70 of FIG. 6 is attached to form window 14. Due to glass layer thickness variations in layer 64 and/or layer 70, it is not possible to directly adhere inner surface 72 of glass layer 70 to surface 68. Accordingly, liquid adhesive 74 is used to fill the air gap that is present between surface 68 and surface 72. As shown in FIG. 6, for example, liquid adhesive 74 may be introduced into the space between inner surface 72 of glass layer 70 and outer surface 68 of PVB layer 60. Adhesive (adhesive layer) 74 may be introduced in liquid form using a needle dispenser or other dispenser that supplies liquid adhesive while layers 64 and 70 are under vacuum to avoid air bubble formation. After the liquid adhesive material is dispensed, heat and/or light may be applied to cure adhesive 74 and thereby form a rigid adhesive layer between surfaces 68 and 72. This rigid adhesive layer has one surface that is adhered to surface 72 and an opposing surface that is adhered to surface 68, thereby completing the adhesive bonding of layers 70 and 64 together to form laminated window 14. Although shown as a single uninterrupted layer of material in FIG. 6, gap-filling layer of polymer formed from adhesive 74 may have multiple discrete areas (e.g., adhesive 74 may be a layer with multiple discrete patches of polymer each filling a respective area where an air is present). The arrangement of FIG. 6 in which adhesive 74 is a single gap-filling polymer layer is illustrative. Adhesive 74, which may sometimes be referred to as optically clear adhesive, may be formed using any suitable liquid adhesive such as an acrylic adhesive, epoxy, or other adhesive compatible with the polymer material forming layer 60 (e.g., an adhesive exhibiting good adhesion with layer 60, etc.). Layers 74 and 60 may be formed using the same type of polymer material or may be formed using different polymer. In the example of FIG. 6, PVB layer 60 is between adhesive layer 74 and inner glass layer 64. If desired, adhesive layer 74 may be located between PVB layer 60 and inner glass layer 64. The thickness of layer 60 may be 0.76 mm, at least 0.3 mm, less than 3 mm, 0.2-2 mm, or other suitable thickness. The thickness of layer 74 may be 0.2-2 mm, at least 0.1 mm, at least 0.2 mm, at least 0.4 mm, at least 0.8 mm, less than 3 mm, less than 2 mm, less than 1 mm, or less than 0.5 mm.

The illustrative configuration of window 14 in FIG. 6 has two glass layers. Window configurations with additional glass layers and/or other layers of material may be used in forming window 14, if desired. As one example, window 14 may have three or more glass layers each of which is laminated to the next with an intervening stack formed from a PVB layer and an associated gap-filling adhesive layer such as layer 74 of FIG. 6.

To help reduce light reflections at the interfaces between the layers of window 14, the refractive indices of the layers of window 14 may be matched to each other. As an example, the refractive index of layer 74 and/or the refractive index of layer 60 may differ from the refractive index of layers 64 and 70 by less than 0.15, less than 0.1, less than 0.05, or less than 0.03 (as examples).

In addition to or instead of filling the gap between layer 60 and layer 70 with liquid adhesive, layer 60 may be pre-formed to a desired gap-filling shape with a non-uniform thickness. As an example, layer 60 may be a PVB layer or other solid polymer film that, before being used to attach layers 70 and 64 together, is molded in a molding tool or otherwise shaped into the shape depicted collectively by layers 60 and 74 in FIG. 6. With this type of arrangement, layer 60 will have a non-uniform thickness configured to fill the gap between layers 64 and 70 so that no air gaps are present between these layers. As a result, liquid adhesive layer 74 may be partly or completely omitted. Other types of pre-formed non-uniform-thickness polymer interlayers may be used in coupling layers 64 and 70 together, if desired. For example, one or more other pre-formed solid polymer films (e.g., polymers other than PVB) with non-uniform thicknesses may be used in attaching layers 64 and 70. To help reduce light reflections at the interfaces between these layers, the refractive indices of the pre-formed non-uniform-thickness layer 60 between layers 70 and 64 may have a refractive index value that is matched to that of layers 70 and 64 (e.g., the refractive index value of the pre-formed non-uniform layer 60 may differ from the refractive index of layer 64 by less than 0.15, less than 0.1, less than 0.05, or less than 0.03 and the refractive index value of the pre-formed non-uniform layer 60 may differ from the refractive index of layer 70 by less than 0.15, less than 0.1, less than 0.05, or less than 0.03.

If desired, one or more optical layers may be formed between inner glass layer 64 and outer glass layer 70. As shown in FIG. 7, for example, optical layer 76 may be embedded in adhesive layer 74.

In an illustrative configuration, layer 76 includes a sheet of glass, polymer, or other transparent material forming a light guide core layer that is configured to guide light laterally across window 14 in accordance with the principal of total internal reflection. The core layer may be sandwiched between a pair of respective cladding layers and/or layer 74 may have a reduced refractive index relative to the core layer to serve as cladding for the core layer. In arrangements in which layer 76 is used in forming a light guide, a light source such as a light-emitting diode coupled to an edge of the light guide may supply light that is conveyed laterally across window 14 and subsequently scattered out of the light guide layer at one or more locations across the surface of the light guide layer (e.g., areas with embedded light-scattering structures). In this way, the light guide layer may serve as a source of internal illumination for interior 20.

In another illustrative configuration, layer 76 includes an electrically adjustable light modulator layer. Layer 76 may, as an example, include a guest-host liquid crystal layer that is adjusted by the control circuitry of system 10. The light transmission of layer 76 may be adjusted electrically by adjusting the strength of a control signal supplied to layer 76 from the control circuitry of system 10. This allows windows 14 to be placed in a transparent state, an opaque state (e.g., for ambient light blocking and/or privacy), or an intermediate state (e.g., to reduce ambient light transmission).

One or more additional electrically adjustable layers may be embedded in adhesive layer 74, if desired. For example, layer 76 may include a cholesteric liquid crystal layer that exhibits an electrically adjustable amount of mirror reflectivity, may be an electrically adjustable haze layer such as a polymer dispersed liquid crystal layer that exhibits an adjustable amount of haze, an electrically adjustable color cast layer such as a guest-host liquid crystal layer that exhibits an adjustable color cast, may be an electrically adjustable polarization layer that exhibits an electrically adjustable amount of light polarization, and/or may be any other suitable layer(s) characterized by an electrically adjustable optical properties.

The foregoing is merely illustrative and various modifications can be made to the described embodiments. The foregoing embodiments may be implemented individually or in any combination.

What is claimed is:

1. A vehicle, comprising:
a vehicle body; and
a window in the vehicle body that has a curved cross-sectional profile, wherein the vehicle body and the window separate an interior vehicle region from an exterior region and wherein the window has first and second glass layers laminated together with a first layer of polymer and with a second layer of polymer that is of a different material than the first layer of polymer.

2. The vehicle defined in claim 1 wherein the first glass layer comprises an inner window glass layer having a convex surface, wherein the second glass layer comprises an outer window glass layer having a concave surface, wherein the first layer of polymer comprises a polyvinyl butyral film adhered to the convex surface, and wherein the second layer of polymer comprises liquid adhesive configured to fill a gap between the polyvinyl butyral film and a concave surface.

3. The vehicle defined in claim 1 wherein the first layer of polymer comprises a polyvinyl butyral film.

4. The vehicle defined in claim 1 wherein the first layer of polymer comprises a polymer film adhered to the first glass layer and wherein the second layer of polymer comprises liquid adhesive configured to fill a gap between the polymer film and the second layer of glass.

5. The vehicle defined in claim 1 wherein the first layer of polymer comprises polyvinyl butyral and wherein the second layer of polymer does not include polyvinyl butyral.

6. The vehicle defined in claim 1 further comprising an optical layer embedded in the second layer of polymer.

7. The vehicle defined in claim 1 further comprising an electrically adjustable layer between the first and second glass layers.

8. The vehicle defined in claim 7 wherein the electrically adjustable layer comprises an adjustable light transmission layer.

9. The vehicle defined in claim 8 wherein the electrically adjustable light transmission layer comprises a guest-host liquid crystal layer.

10. The vehicle defined in claim 7 wherein the electrically adjustable layer is configured to exhibit an adjustable optical property selected from the group consisting of: adjustable color cast, adjustable haze, and adjustable reflectivity.

11. The vehicle defined in claim 6 wherein the optical layer comprises a light guide core layer and wherein the second layer of adhesive is configured to serve as a cladding for the light guide core layer.

12. A vehicle window configured to separate a vehicle interior region from an exterior region, the vehicle window comprising:
an outer window glass layer having a curved cross-sectional profile;
an inner window glass layer having a curved cross-sectional profile;
a first polymer layer adhered to the inner window glass layer and located between the inner window glass layer and the outer window glass layer; and
a second polymer layer formed from a different material than the first polymer layer, wherein the second polymer layer is adhered to the outer window glass layer and is adhered to the first polymer layer.

13. The vehicle window defined in claim 12 wherein the first polymer layer has a first refractive index and wherein the second polymer layer has a second refractive index that differs from the first refractive index by less than 0.1.

14. The vehicle window defined in claim 12 wherein the first polymer layer comprises polyvinyl butyral.

15. The vehicle window defined in claim 14 wherein the second polymer layer comprises liquid polymer adhesive configured to fill a gap between the first polymer layer and the outer window glass layer.

16. The vehicle window defined in claim 15 further comprising an electrically adjustable optical layer embedded in the liquid polymer adhesive.

17. The vehicle window defined in claim 16 wherein the electrically adjustable optical layer comprises a light modulator layer configured to provide an adjustable amount of light transmission.

18. A window, comprising:
a first layer of glass with a convex surface;
a second layer of glass with a concave surface;
a first layer of polymer adhered to the convex surface; and
a second layer of polymer with a first surface adhered to the first layer of polymer and a second surface adhered to the concave surface.

19. The window defined in claim 18 wherein the first layer of polymer comprises a polyvinyl butyral film.

20. The window defmed in claim 19 wherein the second layer of polymer is formed from a different polymer material than the first layer of polymer.

21. The window defmed in claim 20 wherein the second layer of polymer comprises liquid polymer adhesive configured to fill a gap between the first layer of polymer and the concave surface.

22. A window, comprising:
a first layer of glass with a convex surface;
a second layer of glass with a concave surface; and
a polymer interlayer between the convex and concave surfaces, wherein the polymer interlayer has a non-uniform thickness.

23. The window defined in claim 22 wherein the polymer interlayer comprises a pre-formed polyvinyl butyral layer of non-uniform thickness configured to accommodate mismatch in shape between the convex surface and concave surface.

24. The window defmed in claim 23 wherein the polymer interlayer has a first surface attached to the convex surface and an opposing second surface attached to the concave surface.

25. The window defmed in claim 23 further comprising a liquid adhesive layer attached between the polyvinyl butyral layer and concave surface.
